(19) United States
(12) Patent Application Publication
(10) Pub. No.: US 2018/0092282 A1
(43) Pub. Date: Apr. 5, 2018

(54) Double-ended Garden Tool and Tool Kit

(71) Applicant: Jennifer GIBB, Nanaimo (CA)

(72) Inventor: Jennifer GIBB, Nanaimo (CA)

(21) Appl. No.: 15/724,132

(22) Filed: Oct. 3, 2017

(30) Foreign Application Priority Data
Oct. 4, 2016 (CA) 2944083

(51) Int. Cl. A01B 1/20; A01B 1/22; A01D 7/10; A01B 1/02; A01B 1/06

(52) U.S. Cl. CPC A01B 1/20; A01B 1/22; A01B 1/06; A01B 1/022; A01D 7/10

(57) ABSTRACT

A gardening tool having an elongate handle with opposing first and second ends; a first tool implement reversibly attachable to the first end; and a second tool implement reversibly attachable to the second end. The first and second tool implements may be axially rotatable relative to one another. A gardening tool kit comprising the gardening tool described with at least three interchangeable tool implements. The toot implements for the tool and the kit may be one or more rakes, hoes, shovels, edgers, forks, and claws.

### FIELD OF THE INVENTION

The present invention relates to tools. In particular, the present invention relates to gardening tools.

### BACKGROUND OF THE INVENTION

It is known to provide a variety of gardening tools comprising an elongate cylindrical handle having a tool implement at a distal end. For example, it is know to provide a rake implement at the end of a wooden handle.

While a user is using a tool such as a rake, it is common to have to change tools frequently while working on the same project. It is desirable to provide a tool which permits use of more than one implement without changing tools.

Many standard tool handles are not of sufficient length to permit the user to easily reach an efficient work area without reaching and bending. It is desirable, therefore, to provide a tool with a longer handle to increase the work area reachable by a user without stretching and bending thereby reducing body strain.

The present invention offers a solution to these shortcomings of prior art garden tools.

### SUMMARY OF THE INVENTION

There is provided a gardening tool having an elongate handle having opposing first and second ends; a first tool implement reversibly attachable to the first end; and a second tool implement reversibly attachable to the second end. The first and second tool implements may be threadably attachable to the handle or may be attachable by friction fit tubing to the handle.

The first tool implement and second tool implement may be selected from the group of tool implements comprising rakes, hoes, shovels, edgers, forks, and claws, and may be axially rotatable relative to one another. The elongate handle comprises a plurality of sections which may be disassembled for storage and transport.

According to another aspect, there is provided a gardening tool kit comprising the gardening tool and at least three tool implements sold as a kit. The tool implements may be selected from the group of tool implements comprising rakes, hoes shovels, edgers, forks, and claws.

### BRIEF DESCRIPTION OF THE DRAWINGS

A detailed description of the preferred embodiments is provided by way of example only and with reference to the following drawings, in which:

FIG. 1 depicts the gardening tool of the present invention with rake and hoe implements axially aligned; and

FIG. 2 depicts the gardening tool of the present invention with rake and hoe implements rotated 90 degrees relative to one another.

In the drawings, several embodiments of the invention are illustrated by way of example. It is to be expressly understood that the description drawings are only for the purpose of illustration and as an aid to understanding, and are not intended as a definition of the limits of the invention.

### DETAILS DESCRIPTION OF THE INVENTION

As shown in the attached image, there is provided a gardening implement having two different tools on opposing ends of a handle.

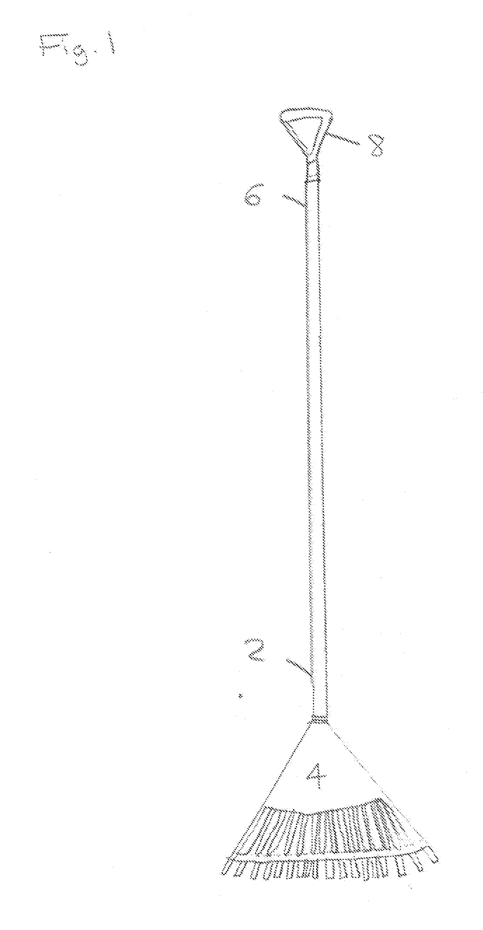

In the preferred embodiment shown in FIG. 1, one end 2 is attached to a rake tool 4, and the opposing end 6 is attached to a scuffle hoe 8. A gardener is able to use the scuffle hoe to loosen weeds from the soil, then use the rake to remove the loosened weeds, without having to change tools.

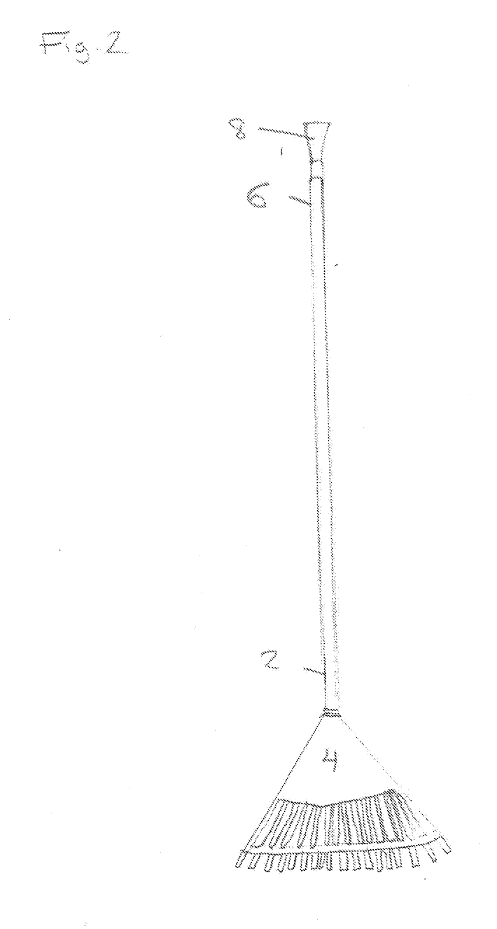

One tool may be at any rotational angle relative to the tool on the opposing end. For example, as shown in FIG. 2, the rake tool may be rotated 90 degrees relative to the hoe tool.

According to alternate embodiments, any combination of two tools may be included in the invention. According to one embodiment, there may be a rake tool at one end and a spade tool (not shown) at the other. The spade may have demarcations to provide guidance in digging to a desired depth, as is required for plating certain plants.

Other tools which may be included are garden hoes, snow shovels, or any other tool which is used with an elongated handle.

The length of the handle may be any length which may be manipulated easily by user. In a preferred embodiment, the handle extending between the tools is longer than a standard tool handle to reduce strain on the users back. For example, in a preferred embodiment the handle may be at least 60 inches long.

The tool handle may be adjustable in length, such as a telescoping handle, or it may comprise separable components which may be disassembled for more compact storage. The components may be nesting tubes, may screw together, or may be attachable by other means.

In a preferred embodiment, one or more of the tool attachments may be manufactured of plastic or other lightweight material to reduce the weight of the overall tool. In a preferred embodiment, the tool handle is a wooden dowel providing strength and low weight.

According to one embodiment, means for suspending the tool from a hook may be attached at one or both ends. In the embodiment shown in the figures, the hoe tool may be used as the hook suspension means.

According to another aspect of the invention, the invention may comprise the tool handle and more than two interchangeable tool attachments selected from the group comprising rakes, hoes, shovels, trowels, edgers, forks, claws, and other garden implements.

From the foregoing, it will be seen that this invention is one well adapted to attain all of the ends and objectives herein set forth, together with other advantages which are obvious and which are inherent to the apparatus. It will be understood that certain features and sub-combinations are of utility and may be employed with reference to other features and sub-combinations. As many possible embodiments may be made of the invention without departing from the scope of the claims, it is to be understood that all matter herein set forth or shown in the accompanying drawings is to be interpreted as illustrative and not in a limiting sense. It will be appreciated by those skilled in the art that other variations of the preferred embodiment may also be practised without departing from the scope of the invention.

What is claimed is:

1. A gardening tool comprising:
a. An elongate handle having opposing first and second ends;
b. A first tool implement reversibly attachable to the first end; and
c. A second tool implement reversibly attachable to the second end.

2. The gardening tool of claim 1, wherein the first and second tool implements are threadably attachable to the handle.

3. The gardening tool of claim 1, wherein the first and second tool implements are attachable by friction fit tubing to the handle.

4. The gardening tool of claim 1, wherein the first tool implement and second tool implement are selected from the group of tool implements comprising rakes, hoes, shovels, edgers, forks, and claws.

5. The gardening tool of claim 1, wherein the first and second tool implements are axially rotatable relative to one another.

6. The gardening tool of claim 1, wherein the elongate handle comprises a plurality of sections which may be disassembled for storage and transport.

7. A gardening tool kit comprising the gardening tool of claim 1 and at least three tool implements.

8. The gardening tool kit of claim 7, wherein the at least three tool implements are selected from the group of tool implements comprising rakes, hoes, shovels, edgers, forks, and claws.
